(19) United States
(12) Patent Application Publication
(10) Pub. No.: US 2005/0147239 A1
(43) Pub. Date: Jul. 7, 2005

(54) METHOD FOR IMPLEMENTING ADVANCED ENCRYPTION STANDARDS USING A VERY LONG INSTRUCTION WORD ARCHITECTURE PROCESSOR

(76) Inventors: Wen-Long Chin, Hsin-Chu Hsien (TW); Kuang-Chih Liu, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,988

(22) Filed: Apr. 6, 2004

(30) Foreign Application Priority Data
Jan. 7, 2004 (TW) 093100386

(51) Int. Cl. H04K 1/00

(52) U.S. Cl. 380/28

(57) ABSTRACT

A method for implementing Advanced Encryption Standards (AES) by a very long instruction word (VLIW) architecture processor. The method includes inputting the instructions for AES into the processor, decoding and scheduling the input instructions, controlling at least one of a plurality of multiplexers to output data from a first register of the processor and/or an arithmetic logic unit to the first register and/or the arithmetic logic unit according to the decoded and scheduled instructions, controlling the arithmetic logic unit to perform operations, and outputting results of the operations to the plurality of the multiplexers.

### BACKGROUND OF INVENTION

1. Field of the Invention

The present invention relates to a method for implementing advanced encryption standards (AES), and more specifically, to a method for implementing AES using a very long instruction word (VLIW) architecture processor.

2. Description of the Prior Art

Advanced encryption standard (AES) is an encryption algorithm recognized by Federal Information Processing Standards (FIPS) for protecting electronic data. AES is a symmetric encryption/decryption standard to encrypt data into cipher text and decrypt the cipher text back into plain text in order to ensure document security. The AES algorithm performs encryption/decryption to 128-bit data blocks by using 128-bit, 192-bit, and 256-bit cryptographic keys. Compared with data encryption standard (DES), AES provides higher security.

AES was originally provided to the federal government of the United States and now is also provided to other businesses or private organizations. For different applications, AES provides different operation modes, wherein OCB (offset code book) mode and CCM (counter mode with CBC MAC) are the most common. There have been many hardware methods for implementing AES disclosed, but since these methods require look-up tables (LUTs) and complicated circuits, a large chip area is accordingly required. In most of the circuits for executing AES, rounds are expanded to accelerate operation. However, the size of the chip is further enlarged and the cost is accordingly increased. Therefore, it is difficult to achieve a balance between cost and performance when implementing AES. Even if we expand all the rounds in the circuit for a fastest operational speed without considering the cost, since the AES algorithm requires operation modes largely different from each other, when these modes exist in a circuit originally designed for a single mode, the performance is not as well as expected. Additionally, it may be required to have a different circuit design for executing the AES algorithm in different operation modes. Therefore, executing AES encryption/decryption using hardware such as a circuit is not flexible.

In addition to hardware, it is also possible to execute AES encryption/decryption using software according to the prior art. Such kind of technology involves executing AES encryption/decryption on a general purpose processor using program code. It is an advantage of such kind of technology that different programs can be used for different operational modes on the same processor without providing more hardware resources so that the cost can be reduced. However, it is slower to execute AES encryption/decryption by software, and this means it may not be possible to fulfill all the requirements by the user or the system.

### SUMMARY OF INVENTION

It is therefore a primary objective of the present invention to provide a method for implementing AES by using different commands on a VLIW architecture processor to execute AES encryption/decryption in different modes, in order to solve the problems in the prior art.

Briefly summarized, a method for implementing advanced encryption standards (AES) by using a very long instruction word (VLIW) architecture processor is disclosed. The processor includes a buffer for storing data, a first register electrically connected to the buffer having a plurality of output ports and a plurality of input ports, an input/output (I/O) controller electrically connected to the buffer and the first register for controlling data to be transmitted from the first register to the buffer or from the buffer to the first register, an arithmetic logic unit (ALU), a plurality of multiplexers each having a plurality of input ports electrically connected to the output port of the first register or the output port of the ALU, and one output port electrically connected to the output port of the ALU and the output port of the first register, a command input port for receiving commands of AES execution, a command register electrically connected to the command input port for temporarily storing the commands input to the command input port, and a command decoder/scheduler electrically connected to the command register, the plurality of multiplexers and the ALU, for decoding and scheduling the commands from the command register, in order to control at least one of the multiplexers to output and input one of the plurality of data units stored in the multiplexer to the ALU, and control the ALU to operate. The ALU includes a plurality of input ports, a plurality of output ports, a basic logic operation unit for executing basic logic operation, and a special AES command unit for executing special logic operation according to AES. The method includes (a) inputting the command of AES execution into the command input port, (b) sending the command stored in the command input port to the command register, (c) sending the command input into the command register to the command decoder/scheduler, (d) decoding and scheduling the command sent from the command register to the command decoder/scheduler, (e) controlling at least one of the multiplexers to output one of the plurality of data units input into the multiplexer from the first register and the ALU to the ALU and the first register, and controlling the ALU to operate, and (f) inputting data generated by the operation of the ALU into the plurality of multiplexers.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a VLIW architecture processor according to the present invention.

FIG. 2 is a flowchart of the method for implementing AES by using a VLIW architecture processor according to the present invention.

### DETAILED DESCRIPTION

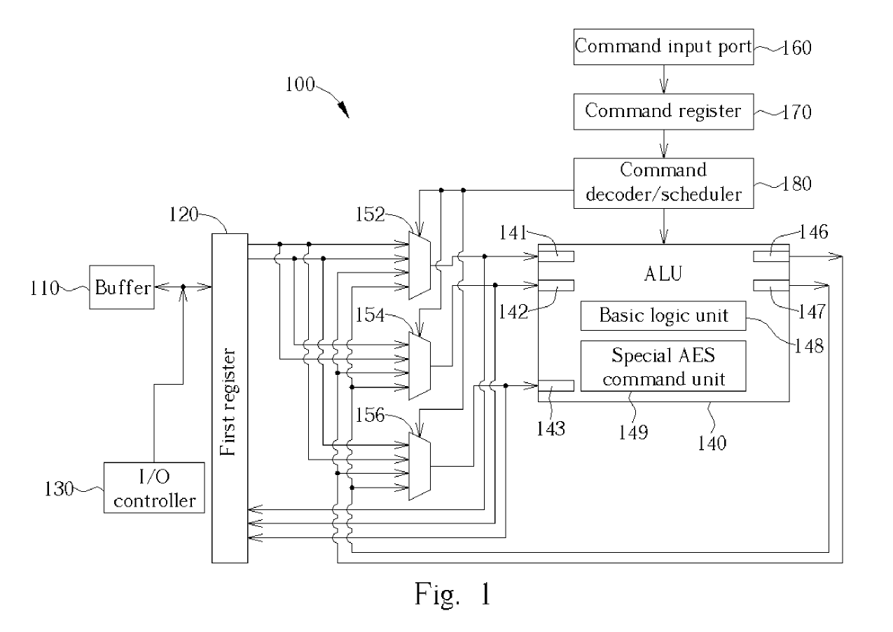

Please refer to FIG. 1 showing a VLIW architecture processor 100 according to the present invention. The VLIW architecture processor 100 includes a buffer 110 for storing data, a first register 120 electrically connected to the buffer 110 for outputting data to the buffer 110 or receiving data from the buffer 110, an input/output (I/O) controller 130 electrically connected to the buffer 110 and the first register 120 for controlling data transmission from the first register 120 to the buffer 110 or from the buffer 110 to the first register 120, and an arithmetic logic unit (ALU) 140. The ALU 140 includes a plurality of input ports 141, 142, 143 and a plurality of output ports 146, 147, a basic logic operation unit 148 for executing basic logic operations, and a special AES command unit 149 for executing special logic operations according to AES. The first register 120 includes a plurality of output ports and a plurality of input ports. The processor 100 further includes a plurality of multiplexers 152, 154, 156 having a plurality of input ports and one output port each for receiving data from the first register 120 or the ALU 140 and outputting data to the ALU 140 or the first register 120, a command input port 160 for receiving commands of AES execution, a command register 170 electrically connected to the command input port 160 for temporarily storing the commands input to the command input port 160, and a command decoder/scheduler 180 electrically connected to the command register 170, the plurality of multiplexers 152, 154, 156, and the ALU 140 for decoding and scheduling the commands from the command register 170 in order to control at least one of the multiplexers to output and input one of the plurality of data units stored in the multiplexer to the ALU 140 and control the ALU 140 to operate. When executing the method according to the present invention, the I/O controller 130 controls the direction of data transmission between the buffer 110 and the first register 120 to output plain text and an encryption key from the buffer 110 to the first register 120. According to the present invention, a command of AES execution is input to the command input port 160 to be sent to the command register 170 to store, and then the command stored in the command register 170 is sent to the command decoder/scheduler 180. The command decoder/scheduler 180 decodes and schedules the command from the command register 170 to output it to the plurality of multiplexers 152, 154, 156 and the ALU 140 in order to control at least one of the plurality of multiplexers to output one of the plurality of data input to the multiplexer from the first register 120 and the ALU 140, to the first register 120 and the ALU 140, and control the ALU 140 to execute the operation corresponding to the decoded and scheduled command. The resulting data from the operation of the ALU 140 is input to the plurality of multiplexers. When all of the commands are executed, i.e. plain text is encrypted or cipher text is decrypted according to AES, the encrypted/decrypted data is output from the multiplexer to the first register 120, and then the I/O controller controls the data to be output from the first register 120 to the buffer 110.

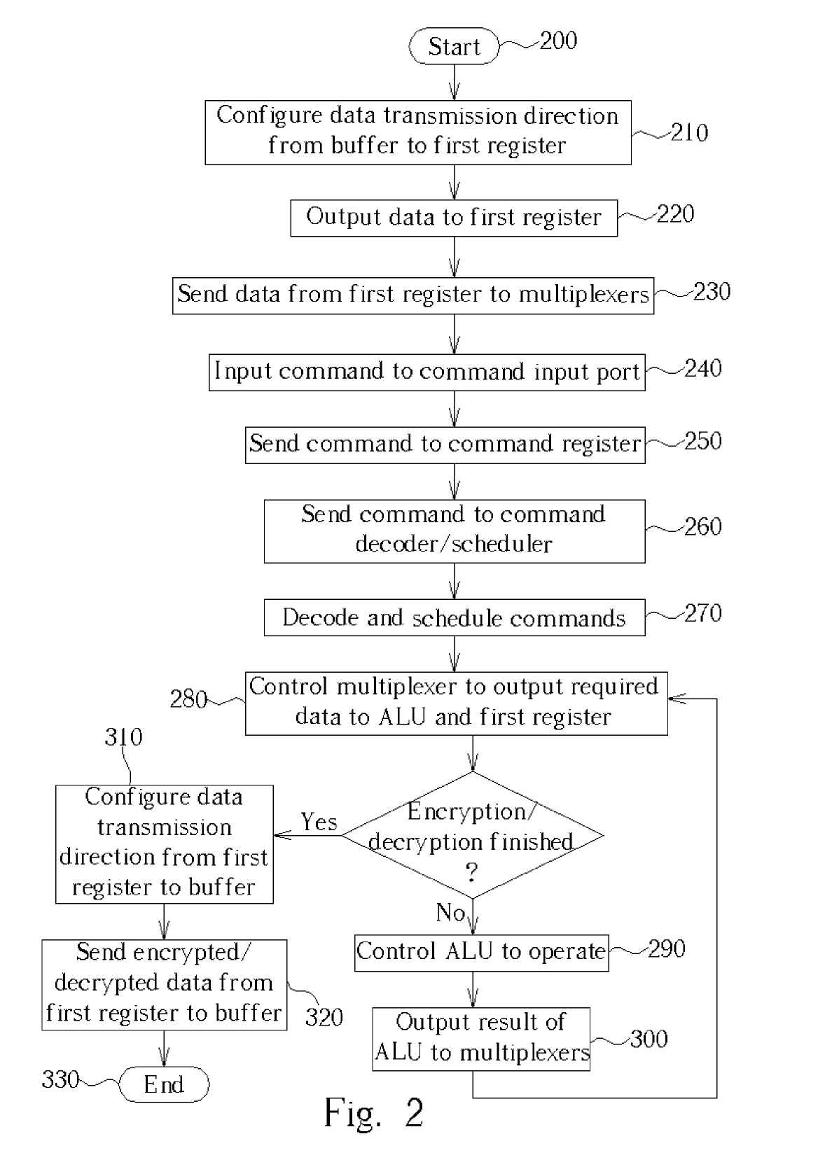

Please refer to FIG. 2 showing a flowchart of the method for implementing AES by using a VLIW architecture processor according to the present invention as follows:

Step 200: Start executing AES encryption/decryption.

Step 210: The I/O controller 130 controls the direction of data transmission between the buffer 110 and the first register 120 to be from the buffer 110 to the first register 120.

Step 220: Output plain text/cipher text data to be encrypted/decrypted and the encryption/decryption key from the buffer 110 to the first register 120.

Step 230: Send the data stored in the first register 120 to the plurality of multiplexers.

Step 240: Input the AES encryption/decryption command to the command input port 160.

Step 250: Send the command input on the command input port 160 to the command register 170.

Step 260: Send the command input on the command register 170 to the command decoder/scheduler 180.

Step 270: Decode and schedule the command input into the command decoder/scheduler 180.

Step 280: Control at least one of the plurality of multiplexers to output at least one of the data input into the multiplexer from the first register 120 and the ALU 140 to the ALU 140 and the first register 120, according to the command decoded and scheduled by the command decoder/scheduler 180.

Step 290: If the encryption/decryption is finished, proceed Step 310. If the encryption/decryption is not yet finished, control the ALU 140 to operate according to the command decoded and scheduled by the command decoder/ scheduler 180.

Step 300:Output the result of the operation by the ALU 140 according to the command decoded and scheduled by the command decoder/scheduler 180, to the plurality of multiplexers 152, 154, 156. Proceed Step 280.

Step 310: The I/O controller 130 controls the direction of data transmission between the buffer 110 and the first register 120 to be from the first register 120 to the buffer 110.

Step 320: Send the data encrypted/decrypted from the first register 120 to the buffer 110.

Step 330: Finish AES encryption/decryption.

According to the method described above and in cooperation with corresponding commands, 128-bit, 192-bit, 256-bit AES (AES-128, AES-192, AES-256) encryption/decryption can be executed. The present invention utilizes a VLIW architecture processor to execute AES encryption/decryption, the processor can be designed to process a plurality of data units or a plurality of commands in parallel. For instance, to simultaneously generate an AES encryption key and encrypt a plain text according to AES, to simultaneously generate an AES encryption key and encrypt a plurality of plain texts according to AES, or to use the same encryption key to simultaneously encrypt a plurality of data unit. Relying on this ability, the method according to the present invention is able to simultaneously execute an SBSR1 (substitute byte shift row 1) command and process the least significant byte (LSB) and the second least significant byte counted for 8 bytes stored in register R0, register R1, register R2, register R3 included in the first register 120; simultaneously execute an SBSR2 command and process the most significant byte (MSB) and the second most significant byte counted for 8 bytes stored in register R0, register R1, register R2, register R3 included in the first register 120; simultaneously execute an MIXADK1 (mix column add round key 1) command and process the data stored in register R0 and register R1; simultaneously execute an MIXADK2 command and process the data stored in register R2 and register R3; simultaneously execute an INVSBSR1 (inverse substitute byte shift row 1) command and process the LSB and the second least significant byte counted for 8 bytes stored in register R0, register R1, register R2, register R3; simultaneously execute an INVSBSR2 command and process the MSB and the second most significant byte counted for 8 bytes stored in register R0, register R1, register R2, register R3; simultaneously execute an INVMIXADK1 (inverse mix column add round key 1) command and process the data stored in register R0 and register R1; simultaneously execute an INVMIXADK2 command and process the data stored in register R2 and register R3; simultaneously execute an SBSR3 command and process the LSB and the second least significant byte counted for 8 bytes stored in register R20, register R21, register R22, register R23 included in the first register 120; simultaneously execute an SBSR4 command and process the MSB and the second most significant byte counted for 8 bytes stored in register R20, register R21, register R22, register R23; simultaneously execute an MIXADK3 command and process the data stored in register R20 and register R21; simultaneously execute an MIXADK4 command and process the data stored in register R22 and register R23; simultaneously execute an INVSBSR3 command and process the LSB and the second least significant byte counted for 8 bytes stored in register R20, register R21, register R22, register R23; and simultaneously execute an INVSBSR4 command and process the MSB and the second most significant byte counted for 8 bytes stored in register R20, register R21, register R22, register R23. In addition to increasing the efficiency of encryption/decryption using parallel processing, it is also possible to input commands corresponding to different AES modes into the VLIW architecture processor. The method according to the present invention can implement AES encryption/decryption in OCB mode or CCM mode, instead of requiring different hardware as in the prior art.

In contrast to the prior art, the method according to the present invention can implement AES encryption/decryption in different modes in cooperation with commands corresponding to the modes. In such a manner, the disadvantage of the prior art requiring different hardware be used to implement AES encryption/decryption in different modes is resolved. In addition, parallel processing by hardware according to the present invention also resolves the disadvantage of the prior art being slow to implement AES encryption/decryption in different modes when only using software so that the AES encryption/decryption is accelerated.

Those skilled in the art will readily observe that numerous modifications and alterations of the device may be made while retaining the teachings of the invention. Accordingly, the above disclosure should be construed as limited only by the metes and bounds of the appended claims.

1. A method for implementing advanced encryption standards (AES) by using a very long instruction word (VLIW) architecture processor, the processor comprising:
a buffer for storing data;
a first register electrically connected to the buffer having a plurality of output ports and a plurality of input ports;
an input/output (I/O) controller electrically connected to the buffer and the first register for controlling data to be transmitted from the first register to the buffer or from the buffer to the first register;
an arithmetic logic unit (ALU) comprising:
a plurality of input ports;
a plurality of output ports;
a basic logic operation unit for executing basic logic operations; and
a special AES command unit for executing special logic operations according to AES;
a plurality of multiplexers each having a plurality of input ports electrically connected to the output port of the first register or the output port of the ALU, and one output port electrically connected to the output port of the ALU and the output port of the first register;
a command input port for receiving commands of AES execution;
a command register electrically connected to the command input port for temporarily storing the commands input to the command input port; and
a command decoder/scheduler electrically connected to the command register, the plurality of multiplexers, and the ALU for decoding and scheduling the commands from the command register in order to control at least one of the multiplexers to output and input one of the plurality of data units stored in the multiplexer to the ALU and control the ALU to operate,
the method comprising:
(a) inputting the command of AES execution into the command input port;
(b) sending the command stored in the command input port to the command register;
(c) sending the command input into the command register to the command decoder/scheduler;
(d) decoding and scheduling the command sent from the command register to the command decoder/scheduler;
(e) controlling at least one of the multiplexers to output one of the plurality of data units input into the multiplexer from the first register and the ALU to the ALU and the first register, and controlling the ALU to operate; and
(f) inputting data generated by the operation of the ALU into the plurality of multiplexers.

2. The method of claim 1, being able to process and execute commands for a plurality of different modes according to AES.

3. The method of claim 1, being able to execute 128-bit, 192-bit, 256-bit AES (AES-128, AES-192, AES-256) encryption/decryption.

4. The method of claim 1, wherein the first register comprises a plurality of registers including register R0, register R1, register R2 and register R3, and the method is able to execute an SBSR1 (substitute byte shift row 1) command and simultaneously process the least significant byte (LSB) and the second least significant byte counted for 8 bytes stored in register R0, register R1, register R2, register R3.

5. The method of claim 4, being able to execute an SBSR2 command and simultaneously process the most significant byte (MSB) and the second most significant byte counted for 8 bytes stored in register R0, register R1, register R2, and register R3.

6. The method of claim 1, wherein the first register comprises a plurality of registers including register R0, register R1, register R2 and register R3, and the method is able to execute an MIXADK1 (mix column add round key 1) command and simultaneously process data stored in register R0 and register R1.

7. The method of claim 6, being able to execute an MIXADK2 command and simultaneously process data stored in register R2 and register R3.

8. The method of claim 1, being able to simultaneously generate an AES encryption key and encrypt a plain text according to AES.

9. The method of claim 1, being able to simultaneously generate an AES encryption key and encrypt a plurality of plain texts according to AES.

10. The method of claim 1, wherein the first register comprises a plurality of registers including register R0, register R1, register R2, and register R3, and the method is able to execute an INVSBSR1 (inverse substitute byte shift row 1) command and simultaneously process the LSB and the second least significant byte counted for 8 bytes stored in register R0, register R1, register R2, and register R3.

11. The method of claim 10, being able to execute an INVSBSR2 command and simultaneously process the MSB and the second most significant byte counted for 8 bytes stored in register R0, register R1, register R2, and register R3.

12. The method of claim 1, wherein the first register comprises a plurality of registers including register R0, register R1, register R2 and register R3, and the method is able to execute an INVMIXADK1 (inverse mix column add round key 1) command and simultaneously process data stored in register R0 and register R1.

13. The method of claim 12, being able to execute an INVMIXADK2 command and simultaneously process data stored in register R2 and register R3.

14. The method of claim 1, wherein the first register comprises a plurality of registers including register R20, register R21, register R22 and register R23, and the method is able to execute an SBSR3 command and simultaneously process the LSB and the second least significant byte counted for 8 bytes stored in register R20, register R21, register R22, and register R23.

15. The method of claim 14, being able to execute an SBSR4 command and simultaneously process the MSB and the second most significant byte counted for 8 bytes stored in register R20, register R21, register R22, and register R23.

16. The method of claim 1, wherein the first register comprises a plurality of registers including register R20, register R21, register R22 and register R23, and the method is able to execute an MIXADK3 command and simultaneously process data stored in register R20 and register R21.

17. The method of claim 16, being able to execute an MIXADK4 command and simultaneously process data stored in register R22 and register R23.

18. The method of claim 1, wherein the first register comprises a plurality of registers including register R20, register R21, register R22 and register R23, and the method is able to execute an INVSBSR3 command and simultaneously process the LSB and the second least significant byte counted for 8 bytes stored in register R20, register R21, register R22, and register R23.

19. The method of claim 18, being able to execute an INVSBSR4 command and simultaneously process the MSB and the second most significant byte counted for 8 bytes stored in register R20, register R21, register R22, and register R23.

20. The method of claim 1, being able to execute AES encryption/decryption in OCB (offset code book) mode and CCM (counter mode with CBC MAC) mode.

21. The method of claim 1, being able to use the same encryption key to simultaneously encrypt a plurality of data units.
